(19) United States
(12) Patent Application Publication
(10) Pub. No.: US 2008/0198149 A1
(43) Pub. Date: Aug. 21, 2008

(54) DISPLAY DEVICE AND DRIVING METHOD THEREOF

(75) Inventors: Keitaro YAMASHITA, Kobe (JP); Yasuyuki Onda, Kobe (JP)

Correspondence Address: VENABLE LLP, P.O. BOX 34385, WASHINGTON, DC, 20043-9998, US

(73) Assignee: TPO Displays Corp., Chu-Nan (TW)

(21) Appl. No.: 12/030,464

(22) Filed: Feb. 13, 2008

(30) Foreign Application Priority Data
Feb. 13, 2007 (JP) 2007-031849

(51) Int. Cl. G06F 3/038

(52) U.S. Cl. 345/204

(57) ABSTRACT

To apply the overdriving technique to a display device provided with a gate driver circuit on a glass substrate for improving the liquid crystal response time.

A gate driver circuit is formed on a glass substrate of a display panel and includes a plurality of gate driver units that are connected to respective gate lines GL. A control circuit controls the gate driver circuit so that the gate driver units sequentially drive the plurality of gate lines GL. The control circuit drives one gate line GL in a first period in each line period, while driving another gate line GL in a second period in each line period. The control circuit causes a delay in driving each gate line GL in the second period from the driving of each gate line GL in the first period with a delay time equal to the time for a plurality of gate lines.

### BACKGROUND OF THE INVENTION

1. Field of the Invention

The present invention relates to a display device having a gate driving circuit that is formed on a glass substrate, more specifically to a gate driving technology suitable for overdriving.

2. Description of the Related Art

Conventionally, in an active matrix display device, a plurality of gate lines and a plurality of data lines are provided on a glass substrate for disposing a plurality of pixels in a matrix. Such gate lines are sequentially driven by a gate driver circuit.

Known as one of conventional display devices is a display device provided with an amorphous silicon gate driver circuit that is formed at an adjacent area to a display area on a glass substrate. In this type of display device, the gate driver circuit is in the form of a shift register and drives each gate line once in a frame period.

Although such display device has a technical merit of reducing the number of wires, it is not easy to drive each gate line for more than once in one frame period because a plurality of shift registers are connected in series in the gate driver circuit.

This poses a problem in applying an overdriving technique. The overdriving technique is a technique for improving liquid crystal response time. In the overdriving technique, each pixel is driven by an overdriving voltage that is higher than the target voltage. However, a conventional display device provided with an amorphous silicon gate driver circuit on a glass substrate is not suitable to apply such overdriving technique because it is constructed to drive each gate once in one frame period.

In order to apply the overdriving technique, one may consider operating the gate driver circuit at a speed that is twice as fast as the normal driving speed. However, even if it is possible to drive to an overdriving voltage, it is impossible to set the driving interval to any desired time because the time interval from the overdriving voltage driving to the target voltage driving is fixed.

One may consider doubling the number of shift registers. However, it poses a problem of unduly increasing the circuit scale.

A conventional overdriving technique is disclosed in, for example, the following Patent Document 1:

[Patent Document 1] Japanese patent publication no. 2003-162256

### SUMMARY OF THE INVENTION

The present invention is made in consideration of the above circumstances. It is an object of the present invention to provide a display device including a gate driver circuit on a glass substrate and applying the overdriving technique for improving the liquid crystal response time.

One embodiment of the present invention is a display device having a plurality of gate lines and a plurality of data lines formed on a glass substrate, comprising: a gate driver circuit formed on the glass substrate and having a plurality of gate driver units connected to the plurality of gate lines; and a control circuit for controlling the gate driver circuit so that the plurality of gate driver units sequentially drive the plurality of gate lines; wherein the control circuit controls to drive one gate line in a first period in each line period and drive another gate line in a second period in each line period so that the driving of each gate line in the second period is delayed from the driving of the same gate line in the first period by the time equal to a plurality of gate lines.

Another embodiment of the present invention is a display device having a plurality of gate lines and a plurality of data lines formed on a glass substrate, comprising: a gate driver circuit formed on the glass substrate and having a plurality of gate driver units connected to the plurality of gate lines; and a control circuit for controlling the gate driver circuit so that the gate driver units sequentially drive the plurality of gate lines; wherein the control circuit drives different gate lines in a plurality of different periods set in each line period, and the driving of one gate line is shifted in a plurality of different periods by the time equal to plural lines.

Another embodiment of the present invention is a driving method of a display device having a plurality of gate lines and a plurality of data lines formed on the glass substrate, and a gate driver circuit formed on the glass substrate and having a plurality of gate driver units connected to the plurality of gate lines, comprising the steps of: controlling the gate driver circuit so that the plurality of gate driver units sequentially drive the plurality of gate lines, driving one gate line in a first period in each line period, and driving another gate line in a second period in each line period, thereby causing a delay of driving each gate line in the second period from the driving of the same gate line in the first period by the time equal to a plurality of gate lines.

Another embodiment of the present invention is a driving method of a display device having a plurality of gate lines and a plurality of data lines formed on the glass substrate, and a gate driver circuit formed on the glass substrate and having a plurality of gate driver units connected to the plurality of gate lines, comprising the steps of: controlling the gate driver circuit so that the plurality of gate driver units sequentially drive the plurality of gate lines, and driving different gate lines in a plurality of different periods set in each line period, thereby shifting the driving of one gate line in a plurality of different period for the time equal to a plurality of lines.

The display device having a gate driver circuit on a glass substrate according to the present invention is able to drive each gate line more than one time in one frame period, thereby enabling to improve the liquid crystal response time by applying the overdriving technique.

### BRIEF DESCRIPTION OF THE DRAWINGS

FIG. 1 is a schematic to show a conventional display device.

FIG. 2 is a schematic to show a first embodiment of the display device.

FIG. 3 is a schematic to describe the operation of the first embodiment of the display device.

FIG. 4 shows the pre-charge circuit prior to pre-charge.

FIG. 5 shows the pre-charge circuit in the pre-charge state in the pre-charge period.

FIG. 6 is a second embodiment of the display device.

### DETAILED DESCRIPTION OF THE PREFERRED EMBODIMENTS

The present invention will be described in detail hereunder. It is to be noted, however, that the following detailed description and the accompanying drawings are not intended to restrict the present invention. Instead, the scope of the present invention should be defined by the claim for patent.

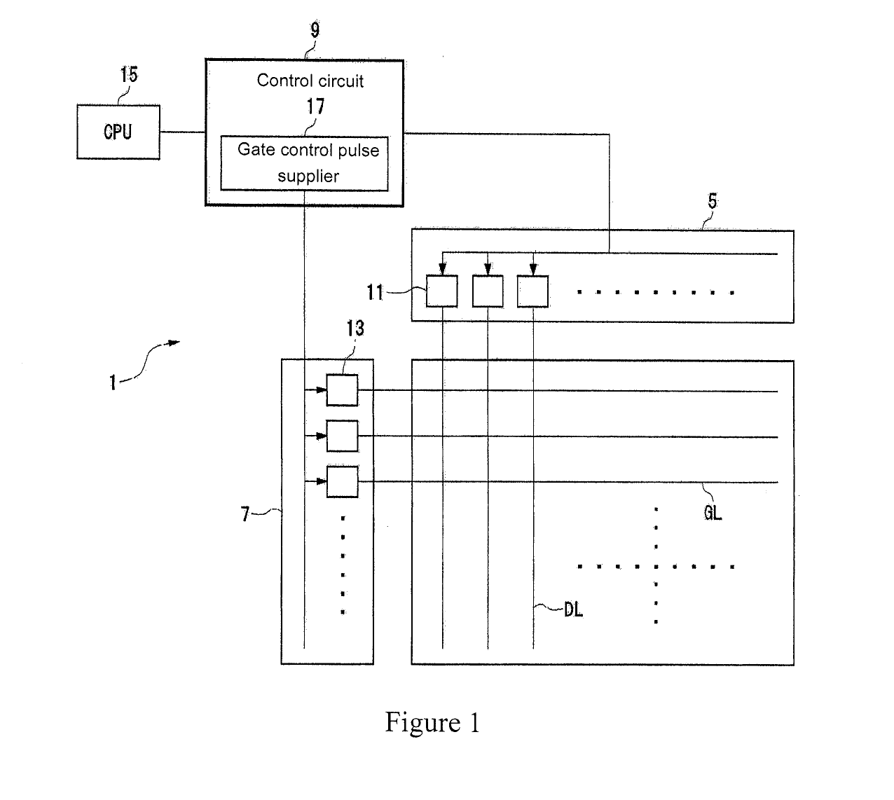

FIG. 1 shows the construction of an embodiment of the display device. The display device 1 comprises a display unit 3, a data driver circuit 5, a gate driver circuit 7 and a control circuit 9.

The display unit 3 has a plurality of data lines DL and a plurality of gate lines GL that are crossed to each other. Cross points of the plurality of data lines DL and the plurality of gate lines GL define respective pixels and a plurality of pixels are disposed in matrix.

The data driver circuit 5 is a circuit for supplying to the plurality of data lines DL data voltage in response to an image to be displayed. The data driver circuit 5 includes a plurality of data driver units 11 that are connected to respective data lines DL. Each data driver unit 11 supplies necessary data to the respective data line DL to which the data driver unit 11 is connected.

The gate driver circuit 7 is a circuit for sequentially driving the plurality of gate lines GL. The gate driver circuit 7 includes a plurality of gate driver units 13 connected to the plurality of gate lines GL. Each gate driver unit 13 has a shift register for driving the gate lines GL by supplying a gate driving signal to the gate lines GL. The gate driving signal is also a pulse signal and is known as a gate pulse.

The control circuit 9 controls the data driver circuit 5 and the gate driver circuit 7 in response to an image data that is supplied from a CPU 15, thereby displaying an image on the display unit 3.

The control circuit 9 includes a gate control pulse supplier 17 for controlling the gate driver circuit 7. The gate control pulse supplier 17 sequentially supplies the gate control pulse to the plurality of gate driver units 13 in the gate driver circuit 7. Each gate driver unit 13 drives the gate line GL in response to the gate control pulse, thereby sequentially driving the plurality of gate lines GL.

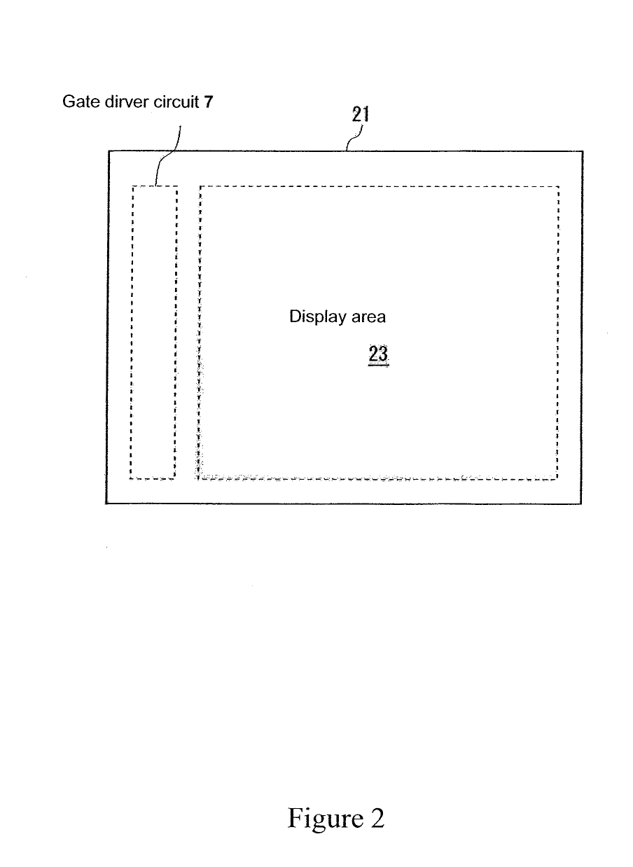

FIG. 2 shows a display panel 21 of the display device 1. The display panel 21 comprises a pair of glass substrates in the gap of which liquid crystal is sealed. The display panel 21 has a display area 23. In the display area 23, the aforementioned plurality of data lines DL and a plurality of gate lines GL are formed on one of the glass substrates. Also, each pixel comprises a pixel electrode and a circuit including a transistor.

In the particular embodiment as shown in FIG. 2, the gate driver circuit 7 is disposed at a location adjacent to the display area 23. The gate driver circuit 7 comprises an amorphous silicon circuit formed on the glass substrate.

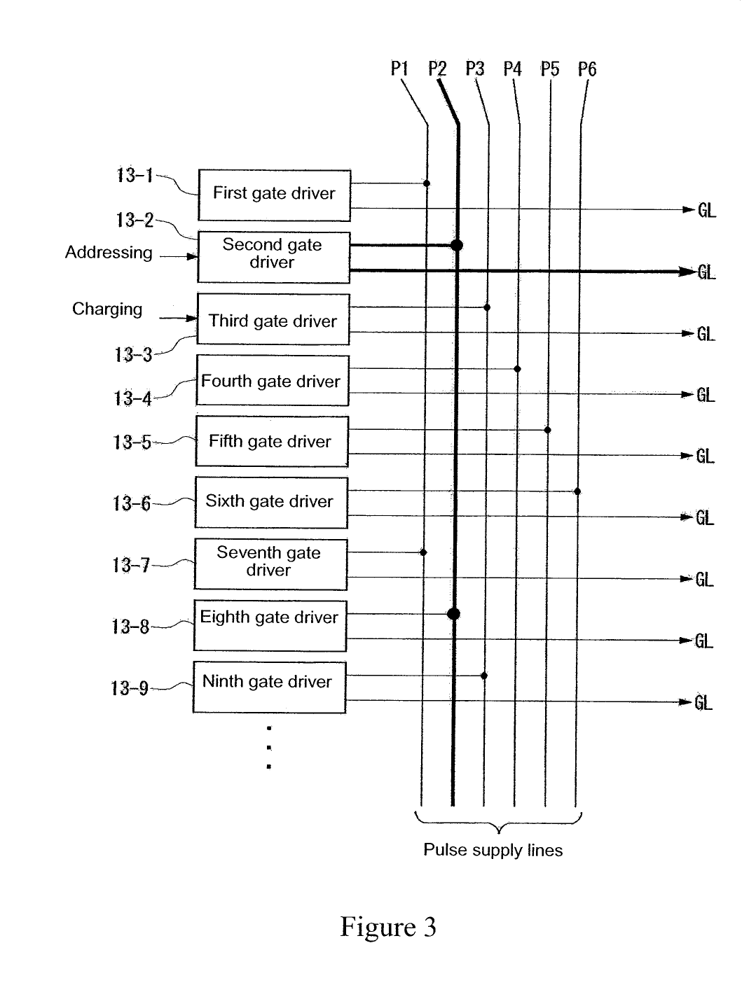

FIG. 3 shows a detailed construction of the gate driver circuit 7. One part of the gate driver circuit 7 is shown in FIG. 3 and first to ninth gate driver units 13 are illustrated. It is to be noted that the gate driver units 13 are hereinafter referred to as gate drivers 13. Similarly, the n-th gate driver is referred to as an n-th gate driver 13-n.

In the particular embodiment as shown in FIG. 3, a six-phase driving technique is applied in which gate control pulses P1˜P6 are supplied from a control circuit 9 by way of pulse supply lines (as described hereinafter, each pulse supply line physically comprises a pair of lines for inverted signals). In the following description, an n-th gate control pulse is simply referred to as a pulse Pn. The sequentially arranged six gate drivers 13 are connected to respective pulses P1˜P6. That is, the first six gate drivers 13 (first to sixth gate drivers) are connected to respective pulse supply lines for pulses P1˜P6. Subsequent six gate drivers 13 (seventh to twelfth gate drivers) are also connected to the pulse supply lines for P1˜P6 (note that only seventh to ninth gate drivers are shown in FIG. 3). Similarly, such connection is repeated for subsequent gate drivers 13.

Each gate driver 13 comprises a shift register and charging of the shift register's internal node to produce the gate propagation is carried out when the gate driver for the next previous stage (i.e., the next upper stream) is addressed and activated (or enabled) by the gate control pulse. When the gate control pulse is supplied in the charging state, the gate driver 13 is addressed and supplying the gate drive signal to the corresponding gate line GL. In the following description, the charging of the shift register's internal node to produce the gate propagation in the gate driver 13 is referred to as the charging of the gate driver.

In the example in FIG. 3, a gate drive signal is outputted so that the pulse P2 is supplied to the second gate driver 13-2 for addressing the second gate driver 13-2 as shown by a thick solid line. In this instance, the third gate driver 13-3 is charged. Although unshown in FIG. 3, when the pulse P3 is then supplied to the third gate driver 13-3 in the charging state, the third gate driver 13-3 is addressed and the fourth gate driver 13-4 is charged. By sequentially supplying the pulses P1˜P6 in the above manner, the gate drivers 13 are sequentially addressed from the upper stage to the lower stage.

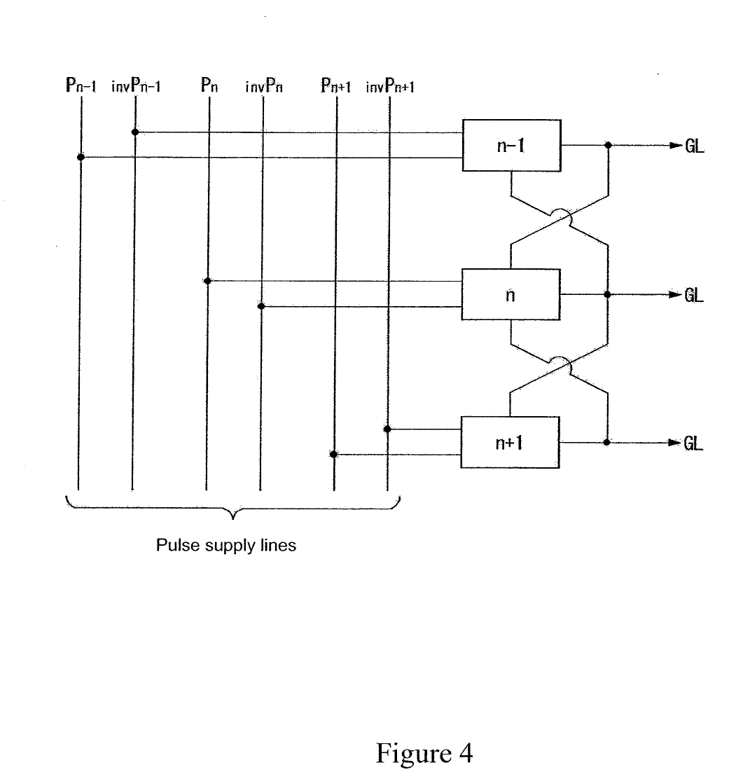

FIG. 4 shows a detailed connection of the gate drivers 13. Only three vertically arranged gate drivers are shown in FIG. 4. The three gate drivers are referred to as the gate drivers n−1, n and n+1.

The three gate drivers n−1, n and n+1 are connected to three different pulse supply lines. Each pulse supply line physically comprises a pair of lines for inputting a pair of inverted signals. More in detail, the pulses Pn−1 and invPn−1 are supplied to the gate driver n−1. The pulses Pn and invPn are supplied to the gate driver n. The pulses Pn+1 and invPn+1 are supplied to the gate driver n+1.

As shown in FIG. 4, opposite pulses are applied to the same terminals of the vertically adjacent gate drivers. For example, in the gate driver n−1, the pulse Pn−1 is supplied to the lower terminal. On the contrary, in the gate driver n, the pulse Pn is supplied to the upper terminal. In the gate driver n+1, the pulse Pn+1 is supplied to the lower terminal.

Although only three pairs of pulse supply lines are shown in FIG. 4 for simplifying the description, there are actually six pairs of pulse supply lines, i.e., 12 lines as described hereinabove with reference to FIG. 3.

Also, it is to be noted that the gate drivers n−1, n and n+1 are interconnected as shown in FIG. 4. The output of the gate driver n−1 is supplied to the gate driver n. The output of the gate driver n is supplied to both of the gate driver n−1 and the gate driver n+1. The output of the gate driver n+1 is also supplied to the gate driver n.

With the above construction, the gate drivers are suitably functioning as a shift register. When the gate driver n−1 is addressed by inputting the pulses Pn−1 and invPn−1, the gate driver n is charged. And when the pulses Pn and invPn are inputted in the charge state, the gate driver n is addressed.

As described hereinabove, the actual gate control pulses are inverted signals and a pair of pulses Pn and invPn are supplied from the pair of lines. However, for simplifying the description, such pair of pulses Pn and invPn are referred simply as the pulse Pn in the following description similarly to the description in FIG. 3.

Now, the operation of the embodiment of the display device 1 according to the present invention will be described. As an outline of the entire operation, the control circuit 9 controls the data driver circuit 5 and the gate driver circuit 7 in such a manner to display an image data that is supplied from the CPU 15. The gate driver circuit 7 sequentially outputs the gate driving signal to the plurality of gate lines GL for sequentially driving these gate lines GL. The data driver circuit 7 supplies the data voltage signal to the plurality of data lines DL while the corresponding gate line GL is being driven.

This particular embodiment employs the overdriving technique. Each gate line GL is driven twice in one frame period. When each gate line GL is driven for a first time, the data driver circuit 5 supplies the overdrive voltage to each pixel. When each gate line GL is driven for a second time, the data driver circuit 5 supplies the target voltage to each pixel. The target voltage is the voltage corresponding to the image to be displayed, which is the voltage corresponding to the required transmissivity of the liquid crystal. The overdriving voltage is set to a higher voltage than the target voltage.

Now, description will be made on the gate driving operation that is unique to the embodiment of the present invention. As described hereinafter, each gate line GL is driven twice in one frame period in order to realize the overdriving technique in this particular embodiment.

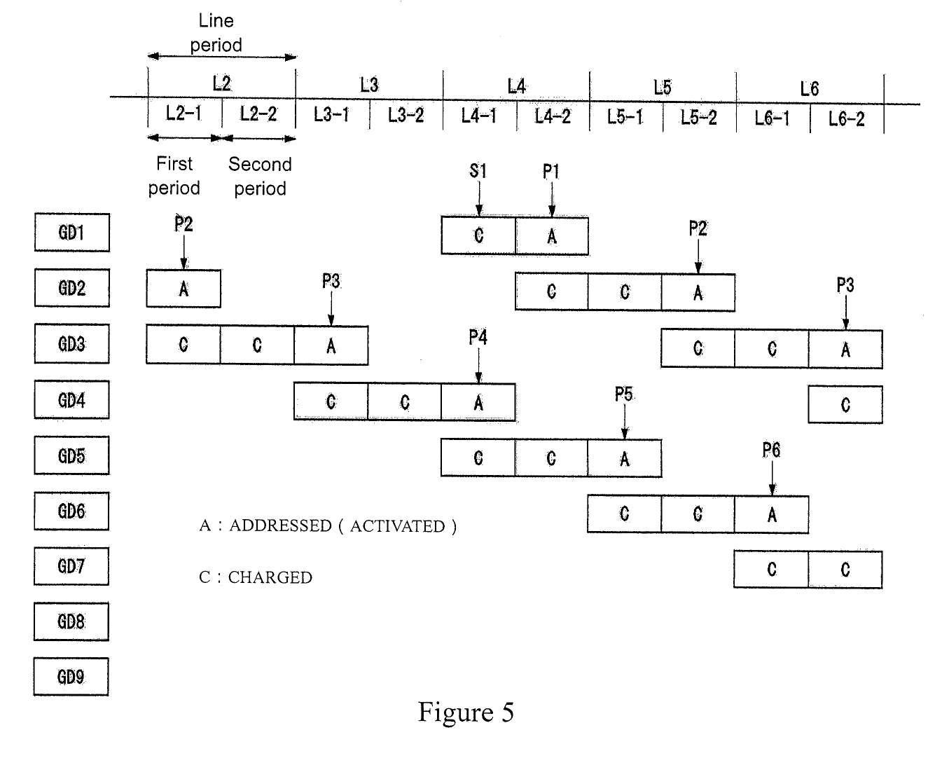

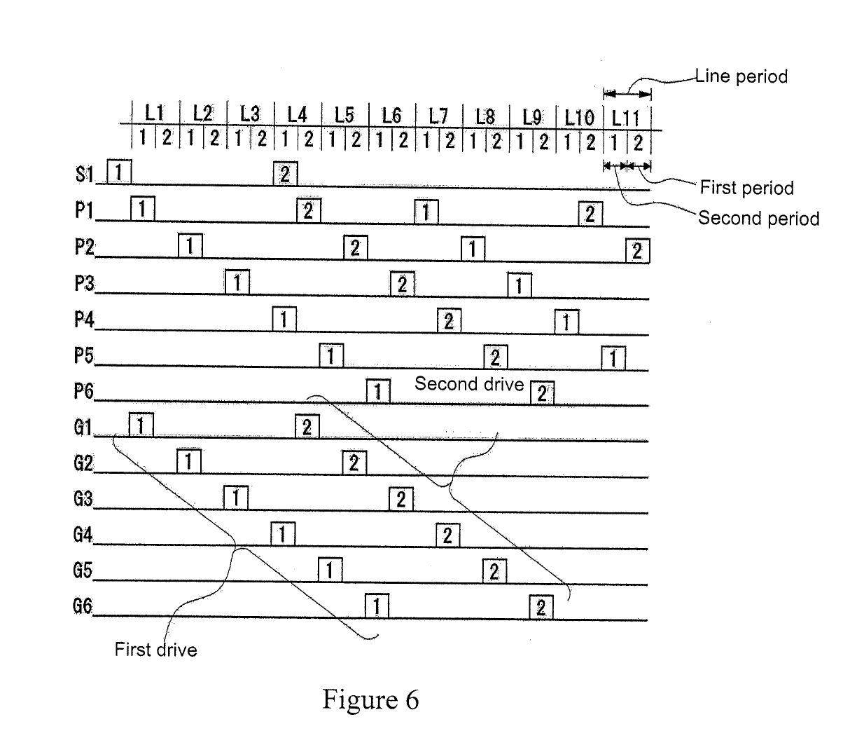

FIG. 5 is a timing chart to show addressing (activation) of the gate driver 13 and charging of the gate driver 13. On the other hand, FIG. 6 is a timing chart to show the timing of supplying the gate control pulse and driving of the gate lines.

In FIGS. 5 and 6, the horizontal axis is a timebase. A plurality of continuous line periods (line cycle times) are set on the timebase and a predetermined number of line periods constitute a frame period. Each line period is divided into a first period and a second period. The first period is the former half, while the second period is the latter half. This means that the first period and the second period are shifted to each other without any overlap. In the following description, reference numerals L1, L2 etc. are given to represent each line period as shown in FIG. 5. Similarly, the first period and the second period of each line period are represented by placing suffix (−1 and −2) as shown in FIG. 5. For example, the first period of the second line period L2 is L2-1.

In FIG. 5, the gate drivers GD1˜GD9 correspond to the first to ninth gate drivers 13-1˜13-9 in FIG. 3. On the other hand, G1˜G9 in FIG. 6 represent the gate lines GL to which the GD1˜GD9 are connected. In FIGS. 5 and 6, P1˜P6 represent the gate control pulses similarly to FIG. 3. S1 is the start pulse that is inputted to the first gate driver GD1 from the control circuit 9 at the start of a series of gate driving.

Now, the gate driving operation will be described by way of the example as shown in FIGS. 5 and 6. Firstly, a reference is made to FIG. 5. The gate driving has started and the second gate driver GD2 is addressed and activated by the pulse P2 at the first period L2-1 in the line period L2. As a result of addressing of the second gate driver GD2, the third gate driver GD3 is charged. Although the pulse P2 is also inputted to the eighth gate driver DG8, it is not charged yet, thereby remaining non-activated. In the next second period L2-2, the pulse is not inputted and the third gate driver GD3 remains in the charging state.

Subsequently, in the first period L3-1 in the line period L3, the pulse P3 is supplied to the third gate driver GD3, thereby addressing the third gate driver GD3 and charging the fourth gate driver GD4. In the next second period L3-2, the fourth gate driver GD4 remains in the charging state.

Subsequently, in the first period L4-1 in the line period L4, the start pulse S1 is supplied from the control circuit 9 to the fourth gate driver GD4, thereby addressing the fourth gate driver GD4 and charging the fifth gate driver GD5. In the second period L4-2, the first gate driver GD1 is addressed by supplying the pulse P1 before addressing the fifth gate driver GD5, thereby charging the second gate driver GD2.

By controlling the gate driver circuit 7 by the pulse from the control circuit 9 in the above manner, gate drive utilizing the first period is performed and then gate drive utilizing the second period is initiated.

Subsequently, in the first period L5-1 in the line period L5, after non-addressing (non-activating) the first gate driver GD1, the pulse P5 is supplied to the fifth gate driver GD5, thereby addressing the fifth gate driver GD5 and charging the sixth gate driver GD6. In this time, the second gate driver GD2 remains in the charging state.

Subsequently, in the second period L5-2 in the line period L5, the pulse P2 is supplied to the second gate driver GD2, thereby addressing the second gate driver GD2 and charging the third gate driver GD3. In this time, the sixth gate driver GD6 remains in the charging state.

Subsequently, in the first period L6-1 in the line period L6, the pulse P6 is supplied to the sixth gate driver GD6, thereby addressing the sixth gate driver GD6 and charging the seventh gate driver GD7. In this time, the third gate driver GD3 remains in the charging state.

The foregoing operation is carried out continuously. The pulses P1˜P6 are repeatedly supplied in each of the first period and the second period and the lower gate drivers are sequentially addressed. In this way, the plurality of gate lines GL are sequentially driven by utilizing the first period in each line period (a first drive) as shown in FIG. 6. Moreover, a plurality of gate lines GL are sequentially driven by utilizing the second period in each line period (a second drive). The second drive is performed at a time delayed by a predetermined time equal to a plurality of lines, which is three lines in the particular embodiment,

In the first drive, the overdriving voltage is supplied to each pixel by way of the data line DL. In the second drive, the target voltage is supplied to each pixel by way of the data line DL. In this way, the overdriving technique is realized, thereby improving the liquid crystal response time.

It is also possible in this embodiment to adjust the timing of supplying the start pulse S1, thereby enabling to discretionarily set the driving time interval (or delay time) between the first drive and the second drive. This means that the driving time interval from the overdriving voltage to the target voltage can be set to an appropriate large value.

This aspect will be described in comparison to the prior art. In prior art, it is proposed to perform gate driving twice at a double speed in order to achieve the overdriving. In this case, a second gate drive is initiated immediately after completing a first gate drive. The conventional method enables to achieve the overdriving. However, it is not impossible to discretionarily set the driving time interval from the overdriving voltage to the target voltage, thereby making it not impossible to set to an appropriate value required by the liquid crystal. On the other hand, the embodiment of the present invention enables to set the driving time interval from the overdriving voltage to the target voltage to an appropriate value.

Now, a practical example of the embodiment according to the present invention will be described.

The present invention can be applied to a three-step overdriving technique. In this case, a pre-drive voltage is used together with the overdriving voltage and the target voltage in the aforementioned example. And the pre-drive voltage is supplied prior to the overdriving voltage.

In case of applying the three-step overdriving technique, each line period is divided into three periods. That is, a pre-drive period is set before the abovementioned first period and the second period. And a pre-drive is performed in the pre-drive period. The pre-drive is performed in advance to the first drive in the first period. The first drive is performed after the pre-drive in a similar manner to perform the second drive after the first drive.

As described hereinabove, each gate line GL may be driven for three or more times in each line period within the scope of this invention, thereby enabling to achieve, for example, the abovementioned three-step overdriving technique without departing from the scope of this invention.

Other than the foregoing, it is possible to use the embodiment of the display device 1 by restricting the abovementioned multiple driving function so as to drive each gate line only once in one line period. Moreover, the present invention should not be restricted to the aforementioned six-phase driving.

The embodiment of the present invention has been described. As described hereinabove, the present invention is a display device having a gate driver circuit on a glass substrate, wherein each gate line is driven more than once in one frame period, thereby enabling to apply the overdriving technique for improving the liquid crystal response time.

Moreover, according to the present invention, the driving interval for driving each gate line more than once can be set discretionarily. For example, in case of performing the overdriving, the driving interval from the overdriving voltage to the target voltage can be set to an appropriate time.

Although the preferred embodiment of the present invention that is believed to be the best mode at the time of filing has been described hereinabove, it is apparent that various modifications of the embodiment may be made and that any and all of these modifications are intended to be covered in the scope and spirit of the present invention.

The display device according to the present invention finds applications as flat display devices for computers, portable terminals, etc.

What is claimed is:

1. A display device having a plurality of gate lines and a plurality of data lines formed on a glass substrate, comprising:
a gate driver circuit formed on the glass substrate and having a plurality of gate driver units connected to the plurality of gate lines; and
a control circuit for controlling the gate driver circuit so that the plurality of gate driver units sequentially drive the plurality of gate lines;
wherein the control circuit controls one gate line to be driven in a first period in each line period and controls another gate line to be driven in a second period in each line period so that the driving of each gate line in the second period is delayed from the driving of the same gate line in the first period equal to the time for driving a plurality of gate lines.

2. A display device of claim 1, wherein the control circuit supplies gate control pulses to different gate driver units connected to different gate lines that are driven in the first period and the second period, each of the gate driver units has a shift register that is charged while driving the next preceding gate line and drives the gate line upon receiving the gate control pulse from the control circuit in the charging state.

3. A display device of claim 1, further comprising a data driver circuit connected to the plurality of data lines, wherein the data driver circuit supplies an overdriving voltage to each of the data lines in the first period and supplies a target voltage corresponding to an image date in the second period.

4. A display device having a plurality of gate lines and a plurality of data lines on a glass substrate, comprising:
a gate driver circuit formed on the glass substrate and having a plurality of gate driver units connected to the plurality of gate lines; and
a control circuit for controlling the gate driver circuit so that the plurality of gate driver units sequentially drive the plurality of gate lines;
wherein the control circuit drives different gate lines in a plurality of different periods that are set in each line period so that driving of one gate line is shifted equal to the time for a plurality of lines in the plurality of different periods.

5. A method of driving a display device having a plurality of gate lines and a plurality of data lines formed on a glass substrate, and a gate driver circuit formed on the glass substrate and having a plurality of gate driver units connected to the gate lines, comprising the steps of:
controlling the gate driver circuit so that the plurality of the gate driver units sequentially drive the plurality of gate lines; and
driving one gate line in a first period in each line period and driving another gate line in a second period in each line period, thereby causing a time delay between the driving of each gate line in the second period and the driving of the same gate line in the first period by the time equal to a plurality of gate lines.

6. A method of driving a display device having a plurality of gate lines and a plurality of data lines formed on a glass substrate, and a gate driver circuit formed on the glass substrate and having a plurality of gate driver units connected to the plurality of gate lines, comprising the steps of:
controlling the gate driver circuit so that the plurality of gate driver units sequentially drive the plurality of gate lines; and
driving different gate lines in different periods set in each line period, thereby shifting the driving of one gate line in the plurality of different periods by the time equal to plural lines.
